(19) United States
(12) Patent Application Publication
(10) Pub. No.: US 2020/0386207 A1
(43) Pub. Date: Dec. 10, 2020

(54) FAIRING PANEL CHARGING SYSTEM

(71) Applicant: K&N Engineering, Inc., Riverside, CA (US)

(72) Inventors: Jere James Wall, Helendale, CA (US); Steve Williams, Cherry Valley, CA (US)

(73) Assignee: K&N Engineering, Inc., Riverside, CA (US)

(21) Appl. No.: 16/893,335

(22) Filed: Jun. 4, 2020

Related U.S. Application Data
(60) Provisional application No. 62/857,679, filed on Jun. 5, 2019.

(51) Int. Cl. F03D 9/32; B60L 53/52; B60K 16/00; F03D 9/11

(52) U.S. Cl. CPC F03D 9/32; B60L 53/52; B60K 2016/006; F03D 9/11; B60K 16/00

(57) ABSTRACT

A system and method are provided for a fairing panel charging system for recharging onboard batteries during operation of an electrically powered vehicle. The fairing panel charging system comprises a fairing panel configured to be coupled with a front of the vehicle. One or more air inlets are disposed in the fairing panel and configured to receive an airstream during forward motion of the vehicle. A wind turbine is disposed rearward of each air inlet and configured to be turned by the airstream. A circuit box is configured to combine electricity received from the wind turbines into a useable electric current. A power cable extends from the circuit box and is configured to supply the useable electric current to any one or more electronic devices, such as any of an onboard battery for powering the vehicle, mobile phones or smart phones, portable music players, tablet computers, cameras, and the like.

### PRIORITY

This application claims the benefit of and priority to U.S. Provisional application, entitled “Fairing Panel Turbine,” filed on Jun. 5, 2019 and having application Ser. No. 62/857,679, the entirety of said application being incorporated herein by reference.

### FIELD

Embodiments of the present disclosure generally relate to the field of electrically powered vehicles. More specifically, embodiments of the disclosure relate to a fairing panel charging system and methods for recharging onboard batteries during operation of an electrically powered vehicle.

### BACKGROUND

Electrically powered vehicles generally solve problems associated with the gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Unfortunately, electrically powered vehicles have certain drawbacks, including limited travel range between battery recharging and excessive time required for recharging the batteries. In generally, the average travel distance between battery recharging for currently available electrically powered vehicles is considerably less than the driving range of gasoline powered vehicles. Further, several hours may be required to recharge the batteries while the vehicle remains inoperative.

Increasing the driving range of electrically powered vehicles between battery recharging downtimes can significantly increase the desirability of operating electrically powered vehicles. One approach to increasing the driving range of electrically powered is by charging the batteries while the vehicle is in motion, such as by way of utilizing air currents as a motive power. Although there have been many contributions to the art of electrically powered vehicles, significant improvements are needed to solve the short travel distance problems associated with such vehicles. There is a continuing interest, therefore, in developing battery recharging systems capable of extending the driving range of electrically powered vehicles during vehicle operation.

### SUMMARY

A system and methods are provided for a fairing panel charging system for recharging onboard batteries during operation of an electrically powered vehicle. The fairing panel charging system comprises a fairing panel configured to be coupled with a front of the vehicle. One or more air inlets are disposed in the fairing panel and configured to receive an airstream during forward motion of the vehicle. A wind turbine is disposed rearward of each air inlet and configured to be turned by the airstream. A circuit box is configured to combine electricity received from the wind turbines into a useable electric current. A power cable extends from the circuit box and is configured to supply the useable electric current to any one or more electronic devices, such as any of an onboard battery for powering the vehicle, mobile phones or smart phones, portable music players, tablet computers, cameras, and the like.

In an exemplary embodiment, a charging system for a vehicle comprises: a fairing panel configured to be coupled with a front of the vehicle; one or more air inlets disposed in the fairing panel and configured to receive an airstream during forward motion of the vehicle; a wind turbine disposed rearward of each of the one or more air inlets and configured to be turned by the airstream; a circuit box configured to combine electricity received from the wind turbines into a useable electric current; and a power cable extending from the circuit box and configured to supply the useable electric current to any one or more electronic devices.

In another exemplary embodiment, the one or more electronic devices comprises any of an onboard battery for powering the vehicle, mobile phones or smart phones, portable music players, tablet computers, cameras, and the like. In another exemplary embodiment, the fairing panel includes a shape and size suitable for being coupled with the front of the vehicle. In another exemplary embodiment, the fairing panel includes multiple mounting holes for receiving hardware fasteners suitable for attaching the fairing panel to the front of the vehicle. In another exemplary embodiment, the one or more air inlets are disposed side-by-side along the width of the fairing panel. In another exemplary embodiment, each pair of adjacent air inlets shares an intervening separator that is configured to contribute to the structural integrity of the fairing panel and to operate in combination with the one or more air inlets to reduce air turbulence.

In another exemplary embodiment, the wind turbines are configured to produce electricity due to being turned by the airstream. In another exemplary embodiment, the wind turbine includes multiple blades coupled with a hub that is generally concentric with an electric generator. In another exemplary embodiment, each of the multiple blades includes a scooped cross-sectional shape that extends along the length of the blade. In another exemplary embodiment, the multiple blades are configured to turn the electric generator in response to the airstream entering through the air inlet and exiting through a rear of the fairing panel. In another exemplary embodiment, the electric generator is configured to produce an electric current during rotating. In another exemplary embodiment, each electric generator includes a power cable that is configured to convey the electric current to the circuit box.

In another exemplary embodiment, the circuit box includes electric circuitry configured to combine the electric currents produced by the wind turbines into the useable electric current. In another exemplary embodiment, the circuit box is configured to synchronize AC electric currents received from the wind turbines so that they can be combined to form the useable electric current. In another exemplary embodiment, the circuit box includes at least one rectifier configured to convert AC electricity received from the wind turbines into DC electricity in the faun of the useable electric current.

In an exemplary embodiment, a method for a charging system for a vehicle comprises: configuring a fairing panel to be coupled with a front of the vehicle; configuring one or more air inlets in the fairing panel to receive an airstream during forward motion of the vehicle; mounting a wind turbine rearward of each of the one or more air inlets such that the airstream turns the wind turbines; configuring a circuit box to combine electricity received from the wind turbines into a useable electric current; and configuring a power cable extending from the circuit box to supply the useable electric current to any one or more electronic devices.

In another exemplary embodiment, configuring the one or more air inlets includes disposing the one or more air inlets side-by-side along the width of the fairing panel. In another exemplary embodiment, mounting the wind turbine includes routing a power cable from an electric generator comprising the wind turbine to the circuit box. In another exemplary embodiment, configuring the circuit box includes configuring the circuit box to synchronize AC electric currents received from the wind turbines so that they can be combined to form the useable electric current. In another exemplary embodiment, configuring the circuit box comprises including at least one rectifier configured to convert AC electricity received from the wind turbines into DC electricity in the form of the useable electric current.

### BRIEF DESCRIPTION OF THE DRAWINGS

The drawings refer to embodiments of the present disclosure in which:

FIG. 1 illustrates a perspective view of an exemplary embodiment of a fairing panel charging system coupled with a front of an electrically powered vehicle, in accordance with the present disclosure;

FIG. 2 illustrates a top plan view of an exemplary embodiment of a fairing panel charging system configured to be coupled with a front of an electrically-power vehicle according to the present disclosure; and

FIG. 3 illustrates a top plan view of an exemplary embodiment of a wind turbine comprising the fairing panel charging system shown in FIG. 2 according to the present disclosure.

While the present disclosure is subject to various modifications and alternative foil is, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first battery,” may be made. However, the specific numeric reference should not be interpreted as a literal sequential order but rather interpreted that the “first battery” is different than a “second battery.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Electrically powered vehicles generally solve problems associated with the gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Drawbacks to electrically powered vehicles include limited travel range between battery recharging and excessive time required for recharging the batteries. Increasing the driving range of electrically powered vehicles between battery recharging downtimes can significantly increase the desirability of operating electrically powered vehicles. One approach to increasing the driving range of electrically powered is by charging the batteries while the vehicle is in motion, such as by way of utilizing air currents as a motive power. Embodiments disclosed herein relate to a fairing panel charging system configured to be mounted onto a vehicle for recharging an onboard battery during operation of the vehicle.

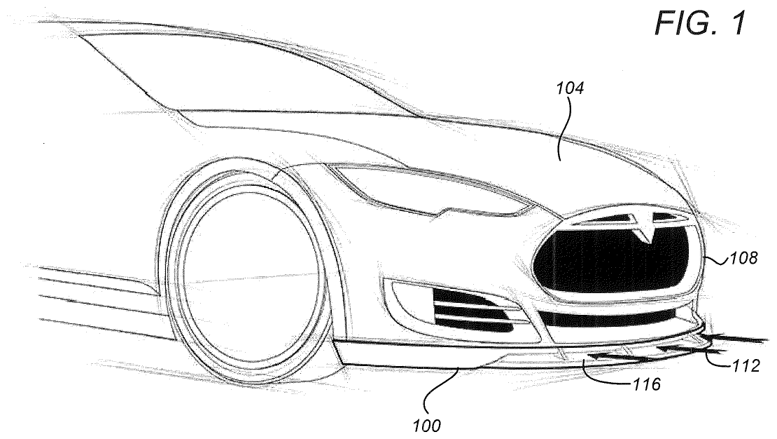

FIG. 1 illustrates a perspective view of an exemplary embodiment of a fairing panel charging system 100 coupled with an electrically powered vehicle 104, in accordance with the present disclosure. The charging system 100 is configured to be coupled with a front 108 of the vehicle 104, such that an airstream 112 incident during forward motion of the vehicle 104 is directed into one or more air inlets 116. As described herein, the airstream 112 passing through the air inlets 116 operates one or more generators whereby an electric current is produced. The electric current may be used for recharging an onboard battery or powering any of various electronic devices, as desired. It is contemplated that such electronic devices may include, but are not limited to, mobile phones or smart phones, portable music players, tablet computers, cameras, and the like.

Although the vehicle 104 shown in FIG. 1, and described herein, is of an electrically powered variety, it is contemplated that the charging system 100 of the present disclosure may be coupled with a wide variety of different vehicles. For example, the vehicle 104 may be any vehicle that includes an onboard battery, such as hybrid electric vehicles, electric vehicles, as well as various fuel-powered vehicles. In some embodiments, fuel-powered vehicles may include any of automobiles, trucks, recreational vehicles, buses, various cargo moving vehicles, locomotives, airplanes, helicopters, airships, boats and ships, and the like, without limitation.

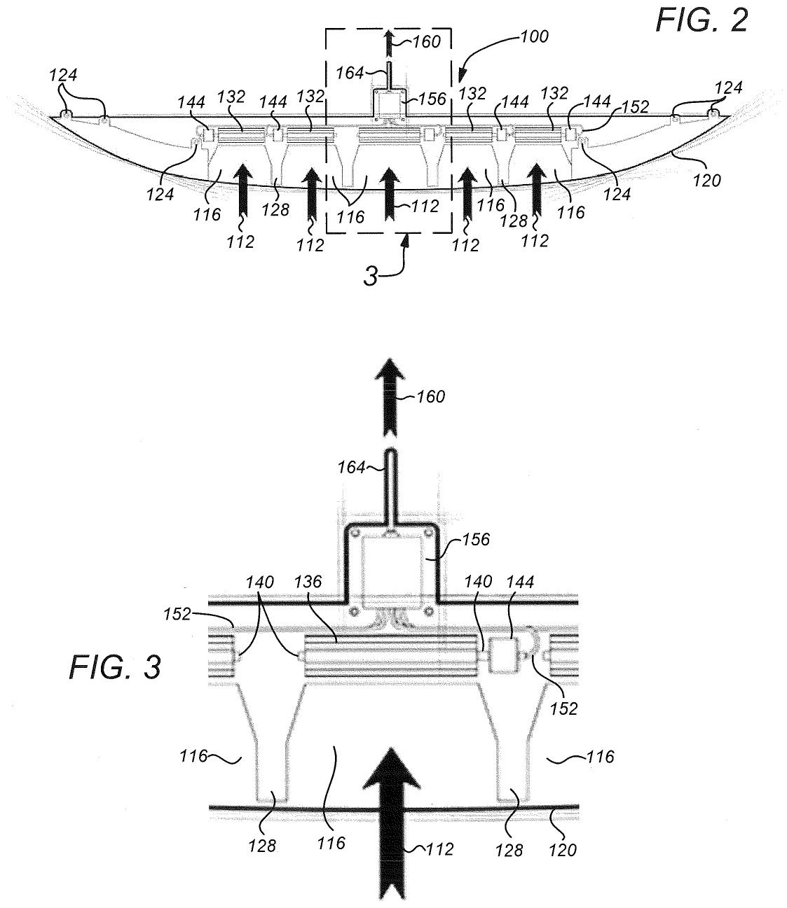

FIG. 2 illustrates a top plan view of the fairing panel charging system 100 of FIG. 1. The fairing panel charging system 100 comprises a fairing panel 120 that is configured to be coupled with the front 108 of the vehicle 104, as shown in FIG. 1. As such, the fairing panel 120 generally includes a shape and size suitable for being coupled with the vehicle 104. Further, the fairing panel 120 includes multiple mounting holes 124 suitable for receiving hardware fasteners suitable for attaching the fairing panel 120 to the front 108 of the vehicle 104. As will be appreciated, any of the hardware fasteners, the number and locations of the mounting holes 124, as well as the shape and size of the fairing panel 120, may be varied, without limitation, so as to accommodate various makes and models of the vehicle 104.

As further shown in FIG. 2, the fairing panel 120 includes multiple air inlets 116 configured to receive the airstream 112 during forward motion of the vehicle 104. In the illustrated embodiment, five air inlets 116 are disposed, side by side, along the width of the fairing panel 120. It is contemplated, however, that in some embodiments, more than or less than five air inlets 116 may be incorporated into the fairing panel 120 without limitation. Further, each pair of adjacent air inlets 116 shares an intervening separator 128. The separators 128 generally are configured to contribute to the structural integrity of the fairing panel 120 and to operate in combination with the air inlets 116 to reduce air turbulence. It is contemplated that, in some embodiments, any of various aerodynamic shapes or features may be incorporated into fairing panel 120 so as to improve entry of the airstream 112 into the air inlets 116, without limitation.

FIG. 3 illustrates a top plan view of an exemplary embodiment of a wind turbine 132 comprising the fairing panel charging system 100, according to the present disclosure. As shown in FIG. 2, the fairing panel charging system 100 includes five wind turbines 132 with each wind turbine 132 positioned rearward of each air inlet 116. As such, during forward motion of the vehicle 104, the airstream 112 flows through the air inlets 116 and turns the wind turbines 132 before exiting at a rear of the fairing panel 120. While being turned, the wind turbines 132 produce electricity that may be used to recharge an onboard battery and/or power one or more portable electronic devices, as described herein.

As shown in FIG. 3, the wind turbine 132 includes multiple blades 136 coupled with a hub 140 that is generally concentric with an electric generator 144. It is contemplated that any suitable number of blades 136 may be coupled with the hub 140, without limitation. Each of the blades 136 includes a scooped cross-sectional shape that extends along the length of the blades 136. As such, the blades 136 are configured to turn the electric generator 144 in response to the airstream 112 entering through the air inlet 116 and exiting through a rear of the fairing panel 120. Further, the blades 136 are configured, in some embodiments, to rotate the electric generator 144 in a clockwise direction for the purpose of producing electricity. It should be recognized, however, that the blades 136 may be configured, in some embodiments, to rotate the electric generator 144 in a counterclockwise direction, as may be desired. As such, the specific configuration of the blades 136 shown in FIGS. 2-3 are not to be construed as limiting in nature, and thus the blades 136 may be altered to accommodate a wide variety of makes and models of the electric generator 144, without limitation.

In general, during forward motion of the vehicle 104 the airstream 112 passes into the air inlets 116, wherein the airstream 112 advantageously causes the blades 136 and the electric generator 144 to rotate. As will be appreciated, the electric generator 144 is configured to produce an electric current during rotating. Each electric generator 144 includes a power cable 152 that is configured to convey the electric current from the electric generator 144 to a circuit box 156. As shown in FIG. 2, the circuit box 156 receives all the power cables 152 that are routed from the wind turbines 132 comprising the charging system 100. The circuit box 156 generally includes electric circuitry configured to combine the electric currents produced by the wind turbines 132 into a useable electric current 160. The circuit box 156 may be configured to synchronize AC electric currents received from the wind turbines 132 so that they can be combined to form the useable electric current 160. In some embodiments, the circuit box 156 may include at least one rectifier configured to convert AC electricity received from the wind turbines 132 into DC electricity in the form of the useable electric current 160. In some embodiments, wherein the wind turbines 132 are configured to generate DC currents, the circuit box 156 may be configured to combine the received DC currents to form the useable electric current 160.

A power cable 164 extending from the circuit box 156 is configured to supply the useable electric current 160 to any one or more electronic devices that are configured to utilize the current 160. It is contemplated that the useable electric current 160 may be used for recharging an onboard battery or powering any of various electronic accessory devices, including, but not limited to, mobile phones or smart phones, portable music players, tablet computers, cameras, and the like. It should be understood that the power cable 164 and the circuit box 156 may be implemented in a wide variety of configurations other than those specifically shown and described herein, without limitation, and without deviating beyond the spirit and scope of the present disclosure.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A charging system for a vehicle, the charging system comprising:
a fairing panel configured to be coupled with a front of the vehicle;
one or more air inlets disposed in the fairing panel and configured to receive an airstream during forward motion of the vehicle;
a wind turbine disposed rearward of each of the one or more air inlets and configured to be turned by the airstream;
a circuit box configured to combine electricity received from the wind turbines into a useable electric current; and
a power cable extending from the circuit box and configured to supply the useable electric current to any one or more electronic devices.

2. The charging system of claim 1, wherein the one or more electronic devices comprises any of an onboard battery for powering the vehicle, mobile phones or smart phones, portable music players, tablet computers, cameras, and the like.

3. The charging system of claim 1, wherein the fairing panel includes a shape and size suitable for being coupled with the front of the vehicle.

4. The charging system of claim 1, wherein the fairing panel includes multiple mounting holes for receiving hardware fasteners suitable for attaching the fairing panel to the front of the vehicle.

5. The charging system of claim 1, wherein the one or more air inlets are disposed side-by-side along the width of the fairing panel.

6. The charging system of claim 5, wherein each pair of adjacent air inlets shares an intervening separator that is configured to contribute to the structural integrity of the fairing panel and to operate in combination with the one or more air inlets to reduce air turbulence.

7. The charging system of claim 1, wherein the wind turbines are configured to produce electricity due to being turned by the airstream.

8. The charging system of claim 1, wherein the wind turbine includes multiple blades coupled with a hub that is generally concentric with an electric generator.

9. The charging system of claim 8, wherein each of the multiple blades includes a scooped cross-sectional shape that extends along the length of the blade.

10. The charging system of claim 8, wherein the multiple blades are configured to turn the electric generator in response to the airstream entering through the air inlet and exiting through a rear of the fairing panel.

11. The charging system of claim 8, wherein the electric generator is configured to produce an electric current during rotating.

12. The charging system of claim 11, wherein each electric generator includes a power cable that is configured to convey the electric current to the circuit box.

13. The charging system of claim 1, wherein the circuit box includes electric circuitry configured to combine the electric currents produced by the wind turbines into the useable electric current.

14. The charging system of claim 13, wherein the circuit box is configured to synchronize AC electric currents received from the wind turbines so that they can be combined to form the useable electric current.

15. The charging system of claim 13, wherein the circuit box includes at least one rectifier configured to convert AC electricity received from the wind turbines into DC electricity in the form of the useable electric current.

16. A method for a charging system for a vehicle, the method comprising:
configuring a fairing panel to be coupled with a front of the vehicle;
configuring one or more air inlets in the fairing panel to receive an airstream during forward motion of the vehicle;
mounting a wind turbine rearward of each of the one or more air inlets such that the airstream turns the wind turbines;
configuring a circuit box to combine electricity received from the wind turbines into a useable electric current; and
configuring a power cable extending from the circuit box to supply the useable electric current to any one or more electronic devices.

17. The method of claim 16, wherein configuring the one or more air inlets includes disposing the one or more air inlets side-by-side along the width of the fairing panel.

18. The method of claim 16, wherein mounting the wind turbine includes routing a power cable from an electric generator comprising the wind turbine to the circuit box.

19. The method of claim 16, wherein configuring the circuit box includes configuring the circuit box to synchronize AC electric currents received from the wind turbines so that they can be combined to form the useable electric current.

20. The method of claim 16, wherein configuring the circuit box comprises including at least one rectifier configured to convert AC electricity received from the wind turbines into DC electricity in the form of the useable electric current.
